(19) United States
(12) Patent Application Publication
(10) Pub. No.: US 2006/0090059 A1
(43) Pub. Date: Apr. 27, 2006

(54) Methods and devices for memory paging management

(76) Inventor: Hsiang-I Huang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/971,621

(22) Filed: Oct. 21, 2004

(51) Int. Cl. G06F 12/10

(52) U.S. Cl. 711/209

(57) ABSTRACT

Methods for memory paging management. First, a page close signal is provided. A page of a memory in response to a memory access request is accessed, and the page close signal is asserted in order to close the page after the accessing of the page.

### BACKGROUND

The present disclosure relates in general to a method and a device for memory paging management. In particular, the present disclosure relates to a method and a device for memory paging management according to page close signals provided by DRAM agents for open-page memory controller architecture.

FIG. 1 is a simplified functional diagram of a memory device 100 that represents any of a wide variety of currently available memory devices. The central memory storage unit of the memory device 100 is a memory array 102 typically arranged in a plurality of banks, with two such banks 104A and 104B shown in the FIG. 1. The memory array 102 includes a plurality of individual memory elements (not shown) for storing data, with the memory elements typically arranged in separately addressable rows and columns. Those skilled in the art often refer to a collectively addressable subset of the array 102 as a “page”. Typically, a single row of memory elements in a bank of the array constitutes a particular page. In FIG. 1, a plurality of pages 106A and 106B are depicted, corresponding with-banks 104A and 104B, respectively.

As known to those skilled in the art, particular locations within the memory array 102 are addressable by Address signals provided by external circuitry (not shown) External circuitry also provides a plurality of control or command signals to designate the particular memory access type and/or sequence of memory accesses. As depicted in FIG. 1, a control/address logic circuit 108 receives control signals and address signals, which may be provided in parallel signal paths, serially, or in some combinations. The control/address logic circuit 108 then applies a plurality of internal control signals to control the timing and sequence of operations accessing the banks 104A and 104B via access circuits 110A and 110B, respectively. Those skilled in the art will understand that the depicted access circuits 110A and 110B represent a collection of various functional circuit components commonly found in memory devices. Examples include row and column address latch, buffer, and decoder circuits, sense amplifiers and I/O gating circuitry, and other well-known circuits adapted for particular memory device implementations. Data written to and read from the memory array 102 is transferred from and to external circuitry via a data I/O circuit 112 and the access circuits 110A and 110B.

One technique used to improve memory throughput is called paging. A page is “opened” when a given row address is strobed in. If a series of accesses are all to the same page, then once the page is open; only column addresses need be strobed in to the memory bank. Thus, the RAS precharge time is reduced for each subsequent access to the open page. Therefore, paging involves leaving a memory page open as long as accesses continue to “hit” within that page. Once an access “misses” the page, the old page is closed and a new page is opened. Opening a new page may incur a precharge time, since only one page may typically be open within a memory bank. If the new page is in the same memory bank, RAS must be precharged before a new page may be opened. If the new page is in a different bank, then the RAS precharge time may already be satisfied for that bank, avoiding an additional precharge delay.

Paging provides the greatest performance enhancement when memory requests are frequently page hits. Typically, applications that access memory addresses sequentially will benefit the most from paging, as they will have a high page hit ratio. However, some applications result in more random memory accesses and therefore have a lower page hit ratio. The opened page must be closed first to perform the precharge operation before memory access operations when a subsequent bank access is to a different page. If an application has a poor page hit ratio, the memory controller may have to frequently switch to new pages. Every time a new page is opened in the same bank, a precharge delay will be incurred. If the page hit ratio is poor, performance is decreased due to additional precharge delay.

U.S. Pat. No. 6,470,416 discloses a method and system for controlling the memory access operation by a central processing unit in a computer system. Other techniques such as dynamic page management are also provided by some patent disclosures, for example, U.S. Pat. No. 6,052,134. The dynamic page management switches between operating modes, e.g. paging mode and auto-precharge mode, depending upon a hit:precharge ratio to access a plurality of memory banks. In the paging mode, the accessed page is left open after the access. In auto-precharge mode, the accessed page should be closed after the access. However, auto-precharge is not performed according to the situation of each data accessing, which results in a lower page hit ratio.

### SUMMARY

Methods and devices for memory paging management are provided. In this regard, embodiments of a method for memory paging management, comprise: providing a page close signal; accessing a page of a memory in response to a memory access request; asserting the page close signal in order to close the page after the accessing of the page.

Embodiments of the invention additionally disclose a device with memory paging management, which comprises: a memory comprising a plurality of pages for storing data; an electronic device providing a memory access request and a page close signal; a memory controller operative to access the page of the memory in response to the memory access request, and to close the page after the access when the page close signal is asserted by the electronic device.

### BRIEF DESCRIPTION OF THE DRAWINGS

Various aspects of embodiments of the invention will become more fully understood from the detailed description, given hereinbelow, and the accompanying drawings. The drawings and description are provided for purposes of illustration only and, thus, are not intended to be limiting of the present invention.

FIG. 1 is -a simplified functional diagram of a memory device 100 that represents any of a wide variety of currently available memory devices.

FIG. 2 is an embodiment of a computer system.

FIG. 3 is a functional block diagram depicting a portion of the memory controller 28.

FIG. 4 is a flowchart illustrating an embodiment of memory paging management.

### DETAILED DESCRIPTION

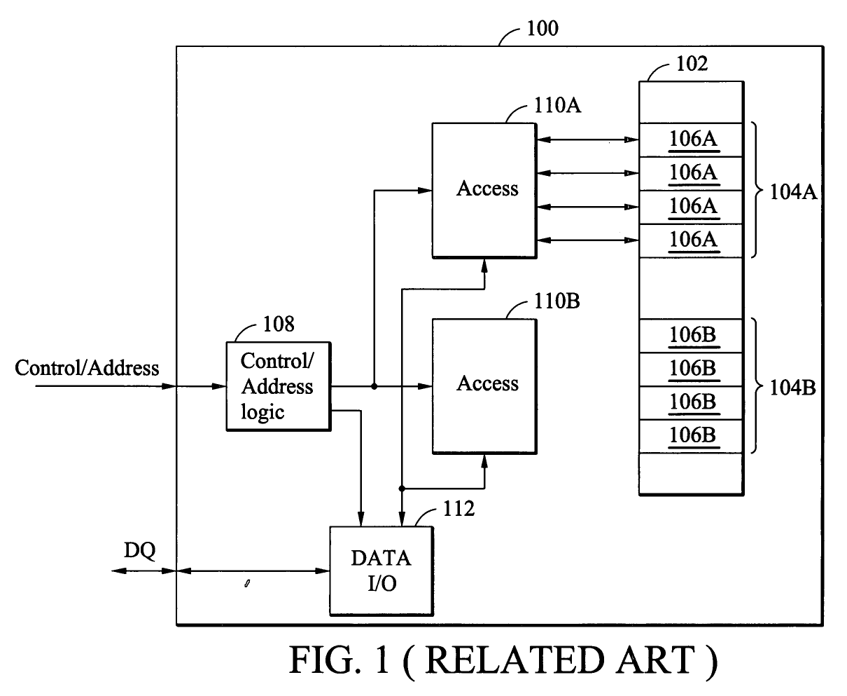

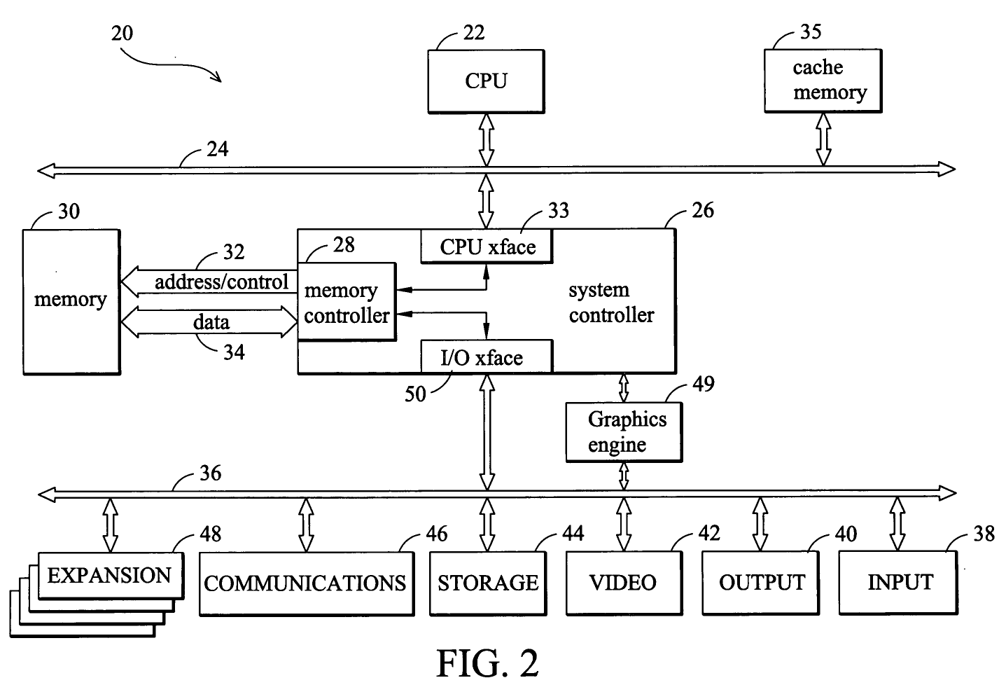

FIG. 2 shows an embodiment of a computer system, identified by numeral reference 20. A central processing unit (CPU), such as a microprocessor 22, is coupled with a system controller 26 by a processor bus 24 that carries address, data, and control signals therebetween. The system controller 26 includes a memory controller 28 for accessing a main memory 30 via a memory address/control bus 32 and a memory data bus 34. As understood by those skilled in the art, the address/control bus 32 may itself be separate, parallel address and control signal paths, or the address and control information may be provided serially, or in some other suitable combination. The main memory 30 may include any of a wide variety of suitable memory devices. Exampary memory devices include dynamic random access memory (DRAM) devices such as synchronous DRAMs, SyncLink DRAMs, or RAMBUS DRAMs, and may include multiple separately addressable memory banks, as described above in connection with FIG. 1.

The system controller 26 includes CPU interface circuitry 33 coupling to the microprocessor 22 with other components of the system controller, such as the memory controller 28. The system controller 26 may also include a cache controller (not shown) for controlling data transfer operations to a cache memory 35 that provides higher speed access to a subset of the information stored in the main memory 30.

The system controller 26 also functions as a bridge circuit (sometimes called a. Northbridge) between the processor bus 24 and a system bus, such as I/O bus 36. The I/O bus 36 may itself be a combination of one or more bus systems with associated interface circuitry (e.g., AGP bus and PCI bus with connected SCSI and ISA bus systems). Multiple I/O devices 38-46 are coupled with the I/O bus 36. A data input device 38, such as a keyboard, a mouse, or similar, is coupled to the I/O bus 36. A data output device 40, such as a printer, is coupled with the I/O bus 36. A visual display device 42, such as a display, is another data output device that is commonly coupled with the I/O bus 36. In addition, the visual display device 42 is controlled by graphics engine 49. A data storage device 44, such as a disk drive, tape drive, optical storage drive, etc., is coupled with the I/O bus 36. A communications device 46, such as a modem, local area network (LAN) interface etc., is coupled with the I/O bus 36. Additionally, expansion slots 48 are provided for future accommodation of other I/O devices not selected during the original design of the computer system 20.

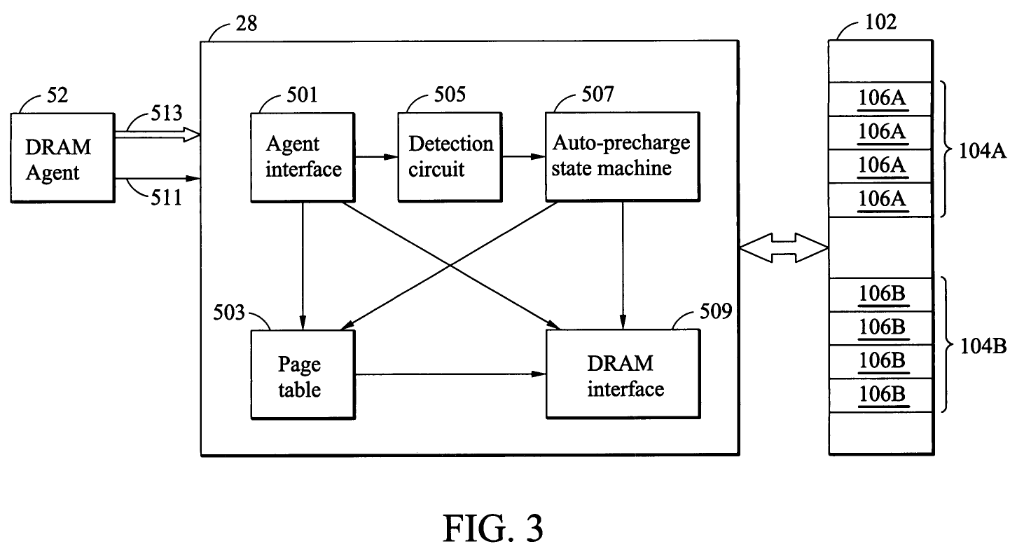

FIG. 3 is a functional block diagram depicting a portion of the memory controller 28. The memory controller 28 comprises agent interface 501, page table 503, detection circuit 505, auto-precharge state machine 507, and DRAM interface 509. DRAM agent 52 may be any of the I/O devices 38-46 shown in FIG. 2. Additionally, the DRAM agent also can be an advanced high-performance bus (AHB) interface or graphics engine 49.

As illustrated in FIG. 3, DRAM agents 52 provide memory access requests over control or command bus 513, and page close signal 511 to access DRAM 102. In some embodiments, the page close signal 511 is asserted by DRAM agent 52 when a memory access request is of a burst type and the last transaction of the burst request occurs. Additionally, the page close signal 511 is also asserted when a memory access request is indicative of access to the DRAM 102 using a discontinuous address. The page close signal 511 is also asserted when a memory access request intends to access a memory bank in different pages or over the boundary of a previously accessed page. Note the page close signal 511 is provided by DRAM agent 52, and asserted under different conditions.

In addition, as the DRAM agent 52 is a display, which generates horizontal scan signals and vertical scan signals, the page close signal 511 is asserted when horizontal scan signals or vertical scan signals indicate scanning to the end of a display line or a frame.

In addition, as the DRAM agent 52 is an advanced high-performance bus (AHB) interface, the page close signal 511 is generated when receiving the last transactions for specified length requests.

Furthermore, in cases where DRAM agent 52 is a graphics engine, the page close signal 511 is asserted when the graphics engine accomplishes drawing a line or an arc.

Memory array 102 is typically arranged in a plurality of banks, with two such banks 104A and 104B for example. The memory array 102 includes a plurality of memory elements (not shown) for storing data, with the memory elements typically arranged in separately addressable rows and columns. Those skilled in the art oftentimes refer to a collectively addressable subset of the array memory 102 as a “page”. Typically, a single row of memory elements in a bank of the array constitutes a particular page. In FIG. 3, a plurality of pages 106A and 106B are depicted, corresponding with banks 104A and 104B, respectively. In addition, elements of memory array 102 are addressable by memory access requests provided by DRAM agents 52.

Memory controller 28 accesses a page of the memory array 102 corresponding to a memory access request provided by DRAM agent 52 via agent interface 501. The agent interface 501 transfers memory access requests, control or command signals, and page close signal 511 provided by DRAM agents 52. Agent interface 501 can also update information, related to a page to be accessed, in a page table 503 to leave the page open after access according to a memory access request.

The page table 503 stores an address corresponding to an open page in the memory array 102 according to a memory access request. Thus, the page can be left open after access in open-page mode architecture.

Detection circuit 505 detects page close signal 511, and outputs a page closing signal to auto-precharge state machine 507. Then, auto-precharge state machine 507 clears the information related to the page to be accessed in the page table 503, and sets a page close flag. Since the related information in the page table 503 indicates that the accessed page left open is cleared, the accessed page will close immediately after the access.

DRAM interface 509 accesses the page according to the memory access request, and closes the accessed page immediately after the access according to the page table and the page close flag. Here, DRAM interface 509 produces the well-known control signal sets and sequences to effect various memory access operations. Example control signals include the well known row address strobe (RAS), column address strobe (CAS), write enable (WE), and/or other memory control signals appropriate to the particular memory device or devices included within the main memory 30.

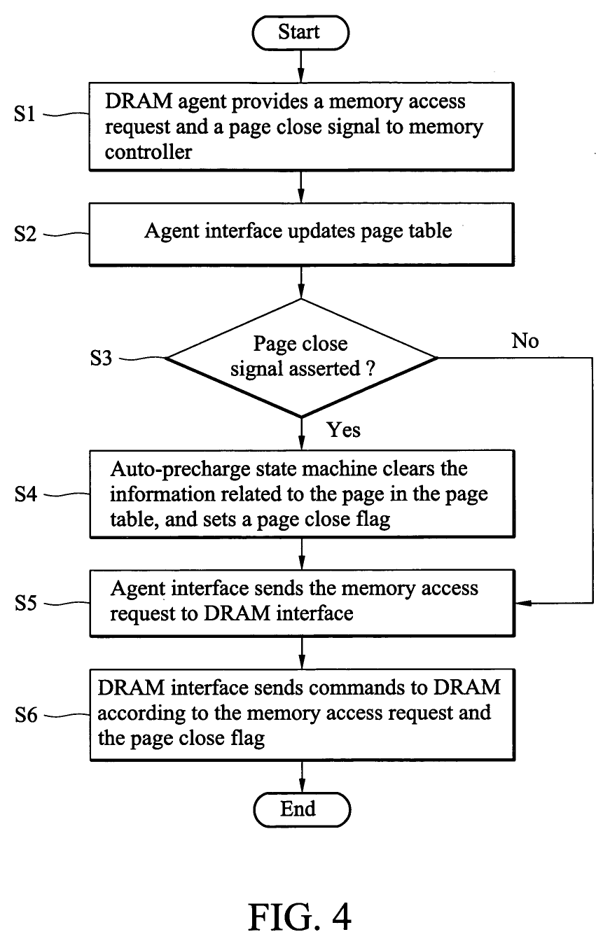

FIG. 4 is a flowchart illustrating an embodiment of the memory paging management.

First, DRAM agent 52 provides a memory access request and a page close signal 511 to memory controller 28 (S1). Next, agent interface 501 receives the memory access request and page close signal 511, and updates information related to a page to be accessed in page table 503(S2). Thus, the page corresponding to the memory access request remaining open after access according to the information recorded in page table 503. Detection circuit 505 detects the state of the page close signal 511 (S3). If the page close signal 511 is asserted, auto-precharge state machine 507 clears the information related to the page to be accessed in the page table 503, and sets a page close flag (S4). Since the information of the accessed page indicates that the accessed page left open is cleared, the accessed page will close immediately after the access. Next, agent interface 501 provides the memory access request to DRAM interface 509 (S5). If the assertion of the page close signal 511 is not detected in step S3, the process goes directly to step S5. According to the memory access request and the page close flag, DRAM interface 509 sends commands to DRAM so as to access the destination page and close it immediately after the access (S6). In some embodiments, the state of the accessed page depends on the information recorded in the page table 503. If the information of the page being accessed still exists in page table 503, such a page is left open after the access. If the information of the page being accessed in page table 503 is cleared in step S4, this page is closed immediately after the access.

In some special DRAM agent conditions, there is a high possibility that different pages in the same bank will be accessed. According to the spirit of the embodiments, an auto-precharge is performed contingent upon the behavior of DRAM agents, without the determination of the DRAM controller. Thus, page hit ratio and DRAM access latency are improved. A system designer can take advantage of all or some of the determination behavior of DRAM agents to configure the timing and performance of the auto-precharge. In addition, the priority of page close signals provided by different DRAM agents can also be defined by a system designer.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for memory paging management, comprising:
providing a page close signal;
accessing a page of a memory in response to a memory access request; and
asserting the page close signal in order to close the page after the accessing of the page.

2. The method for memory paging management as claimed in claim 1, further comprising:
updating information related to a page to be accessed to keep the page to be accessed open after the access according to the memory access request;
detecting an assertion of the page close signal;
clearing the information related to the page to be accessed and setting a page close flag when the page close signal is asserted; and
accessing the page according to the memory access request, and closing the accessed page immediately after the access according to the information related to the page and the page close flag.

3. The method for memory paging management as claimed in claim 1, wherein the page close signal is provided by a device outputting the memory access request.

4. The method for memory paging management as claimed in claim 1, wherein the memory access request is of a burst type.

5. The method for memory paging management as claimed in claim 4, wherein the page close signal is asserted when a last transaction of the memory access request occurs.

6. The method for memory paging management as claimed in claim 1, wherein the page close signal is asserted when the memory access request indicates accessing data in the memory by discontinuous address.

7. The method for memory paging management as claimed in claim 1, wherein the page close signal is asserted when the memory access request indicates accessing data in the memory with different pages.

8. The method for memory paging management as claimed in claim 1, wherein the page close signal is asserted when the memory access request indicates accessing data in the memory over a page boundary of previously accessed data.

9. The method for memory paging management as claimed in claim 3, wherein the device is a display generating horizontal scan signals and vertical scan signals.

10. The method for memory paging management as claimed in claim 9, wherein the page close signal is asserted by the display when horizontal scan signals or vertical scan signals indicate scanning to the end of a display line.

11. The method for memory paging management as claimed in claim 9, wherein the page close signal is asserted by the display when horizontal scan signals or vertical scan signals indicate scanning to the end of a frame.

12. The method for memory paging management as claimed in claim 3, wherein the device is an advanced high-performance bus (AHB) interface, asserting the page close signal when receiving a last transaction for a specified length request.

13. The method for memory paging management as claimed in claim 3, wherein the device is a graphics engine, asserting the page close signal upon accomplishing a drawing of a line or an arc.

14. A device with memory paging management, comprising:
a memory comprising a plurality of pages for storing data;
an electronic device providing a memory access request and a page close signal; and
a memory controller operative to access the page of the memory in response to the memory access request, and to close the page after the access when the page close signal is asserted by the electronic device.

15. The device with memory paging management as claimed in claim 14, wherein the memory controller comprises:
a page table operative to store information of the pages;
an agent interface operative to transfer the memory access request and the page close signal, and to update information, related to a page to be accessed, in the page table to keep the page to be accessed open after the access according to the memory access request;
a detection circuit operative to detect an assertion of the page close signal, and to assert a page closing signal when detecting the assertion of page close signal;
an auto-precharge state machine operative to clear the information related to the page to be accessed in the page table, and to set a page close flag when the page closing signal is asserted; and
a memory interface operative to access the page according to the memory access request, and to close the accessed page immediately after the access according to the page table and the page close flag.

16. The device with memory paging management as claimed in claim 14, wherein the memory access request is of a burst type.

17. The device with memory paging management as claimed in claim 16, wherein the page close signal is asserted when a last transaction of the memory access request occurs.

18. The device with memory paging management as claimed in claim 14, wherein the page close signal is asserted when the memory access request indicates accessing data in the memory by discontinuous address.

19. The device with memory paging management as claimed in claim 14, wherein the page close signal is asserted when the memory access request indicates accessing data in the memory with different pages.

20. The device with memory paging management as claimed in claim 14, wherein the page close signal is asserted when the memory access request indicates accessing data in the memory over a page boundary of previously accessed data.

21. The device with memory paging management as claimed in claim 14, wherein the electronic device is a display operative to generate horizontal scan signals and vertical scan signals.

22. The device with memory paging management as claimed in claim 21, wherein the display asserts the page close signal when horizontal scan signals or vertical scan signals indicate scanning to the end of a display line.

23. The device with memory paging management as claimed in claim 21, wherein the display asserts the page close signal when horizontal scan signals or vertical scan signals indicate scanning to the end of a frame.

24. The device with memory paging management as claimed in claim 14, wherein the electronic device is an advanced high-performance bus (AHB) interface, asserting the page close signal when receiving a last transaction for a specified length request.

25. The device for memory paging management as claimed in claim 14, wherein the electronic device is a graphics engine, asserting the page close signal upon accomplishing drawing of a line or an arc.
